(19) United States
(12) Patent Application Publication
(10) Pub. No.: US 2021/0034737 A1
(43) Pub. Date: Feb. 4, 2021

(54) DETECTION OF ADVERSERIAL ATTACKS ON GRAPHS AND GRAPH SUBSETS

(71) Applicants: Sakif Hossain KHAN, Montreal (CA); Yingxue ZHANG, Montreal (CA); Florence ROBERT-RÉGOL, Montreal (CA); Mark COATES, Montreal (CA); Liheng MA, Montreal (CA)

(72) Inventors: Sakif Hossain KHAN, Montreal (CA); Yingxue ZHANG, Montreal (CA); Florence ROBERT-RÉGOL, Montreal (CA); Mark COATES, Montreal (CA); Liheng MA, Montreal (CA)

(21) Appl. No.: 16/944,073

(22) Filed: Jul. 30, 2020

Related U.S. Application Data
(60) Provisional application No. 62/880,619, filed on Jul. 30, 2019.
(60) Provisional application No. 62/880,626, filed on Jul. 30, 2019.

(51) Int. Cl. G06F 21/55; G06N 3/08; G06N 3/04

(52) U.S. Cl. CPC G06F 21/55; G06F 2221/034; G06N 3/04; G06N 3/08

(57) ABSTRACT

Method and system for detecting potentially perturbed nodes in a graph that comprises potentially perturbed nodes and clean nodes, comprising: calculating, for each of a plurality of nodes of the graph, a discrepancy value in respect of the node, wherein the discrepancy value for each node indicates a statistical discrepancy for classification probabilities associated with the node and classification probabilities associated with neighbouring nodes; fitting a statistical distribution for the discrepancy values for the clean nodes; determining a detection threshold for potentially perturbed nodes based on the statistical distribution; and identifying nodes having a discrepancy value greater than the detection threshold as potentially perturbed nodes.

### CROSS-REFERENCE TO RELATED APPLICATIONS

This application claims the benefit of U.S. Provisional Patent Application No. 62/880,626 filed Jul. 30, 2019, and entitled “DETECTION OF ADVERSERIAL ATTACKS ON GRAPHS”, and U.S. Provisional Patent Application No. 62/880,619 filed Jul. 30, 2019 and entitled “DETECTION OF ADVERSERIAL ATTACKS ON GRAPH SUBSET”, the contents of which are hereby incorporated by reference as if reproduced in their entirety.

### FIELD

This disclosure relates generally to the processing of graphs, and more particularly to detecting perturbed data in a graph and detecting perturbed data in a subset of a graph.

### BACKGROUND

A graph is a data structure consisting of nodes and edges that connect the nodes. Each node represents an object from a set of objects and each edge represents a relationship that connects two nodes. Processing graphs using machine learning based systems is of growing interest due to the ability of graphs to represent objects and their inter-relationships across a number of areas including, among other things, social networks, financial networks, and physical systems. Machine learning based systems are, for example, being developed for graph analysis tasks including node classification, link prediction, sub-graph classification and clustering.

Graph neural networks (GNN) can be used to learn a model of the dependencies between nodes in a graph. GNNs are a class of artificial neural networks (NN) that are configured to operate on the graph domain. NNs in general are computing systems modeled on how biological brains operate. NNs are made up of a number of simple, highly interconnected processing elements, which process information by their dynamic response to external inputs. NNs can learn to perform inference tasks, such as object classification and clustering, by considering examples. NNs typically do not need to be programmed with any task-specific rules. Instead, NNs learn from the examples they process.

GNNs can learn based on the features of individual nodes as well as the relationships between nodes and thus capture structural information about a graph while incorporating data contained in feature attributes of the nodes and edges. GNNs are applicable to a broad array of problems which require learning from data which have irregular but complex structures. For example, social networks can include nodes that specify social media user metadata, a knowledge graph can include nodes that specify factual data, and a citation network can include nodes that specify paper topics and abstracts. The edge connections between these nodes encode information not contained in any given node alone. A key component of a GNN, and graph-based machine learning systems in general, is an aggregating function which is able to consolidate data for a node as well as its neighbours and produce a succinct mathematical description of the local neighbourhood around the node.

Different GNN structures and embedded aggregating functions have been proposed, some of which are also able to capture global patterns in graph structured data while others are crafted to scale to very large graphs (e.g. graphs having millions of nodes, and billions of edges). However, broadly speaking, GNNs often assume that links between nodes reflect homophily, i.e., that connected nodes share common attributes. The design of aggregator functions which take advantage of this assumption has yielded tremendous improvements on learning tasks for graph-structured data.

Unfortunately, reliance on the assumption of homophily can be used to attack a GNN. More precisely, it is possible to subtly alter the local topology around a node in order to induce the GNN to badly mis-classify that node. Indeed, the node itself need not be directly perturbed; it is sometimes sufficient to maliciously manipulate information contained in the node's neighbours. Thus, an adversary can manipulate a data-point (a node that is easily accessible to the adversary, for example) to induce errors in a related but different data point. For instance, given a financial network, an adverse entity can hijack a few easy-to-hack accounts (which are subsequently represented as nodes in a graph) and induce undesirable behavior in respect of connected accounts (also represented as nodes in the graph) which are not controlled by the adverse entity. Hence, in practical deployment scenarios, there are potentially high risks if detection mechanisms are not in place to ameliorate the presence of malicious actors.

In some cases, data associated with a node may be perturbed through non-malicious data corruption, and such corruption could have similar negative effects on a GNN.

In some cases, subsets of nodes of a graph may be perturbed through data corruption.

Accordingly, there is a need for methods and systems that enable for the detection of perturbed data within a graph or a subset of nodes of a graph.

### SUMMARY

The methods and systems described in this disclosure provide a solution that can be applied to detect corrupted information in graph data. In example embodiments, corrupted nodes can be identified based on statistical analysis of information that is embedded in a GNN output in respect of a node and its neighboring nodes. In at least some applications the system will mitigate against flawed and inaccurate classification data being used in downstream processes. In some embodiments, the knowledge of corrupted nodes can be used to remove suspicious nodes and correct graph data before a classifier GNN is trained, thereby resulting in a more accurate classifier GNN. In at least some examples early detection of corrupt data may improve the efficiency and accuracy of downstream processes and/or assist in identifying corrupt or erroneous upstream process. Early detection of corrupt data may also enable more accurate and efficient use of computing resources.

According to a first example aspect is a method for detecting corrupt nodes in a graph that comprises a plurality of corrupt nodes and clean nodes and topology information that defines connections between the nodes. The method includes computing, for each of a plurality of nodes of the graph, a discrepancy value in respect of the node, wherein the discrepancy value for each node indicates a statistical discrepancy for classification probabilities associated with the node and classification probabilities associated with neighbouring nodes; and identifying corrupt nodes based on differences in discrepancy values.

According to some examples of the first aspect, identifying the corrupt nodes is comprises: fitting a statistical distribution for the discrepancy values for the clean nodes; determining a detection threshold for corrupt nodes based on the statistical distribution; and identifying nodes having a discrepancy value greater than the detection threshold as corrupt nodes.

According to one or more of the preceding aspects, the discrepancy value is based on a multi-distribution Jenson Shannon divergence calculation.

According to one or more of the preceding aspects, fitting the statistical distribution comprises using a non-parametric kernel density estimator, and the detection threshold is determined based on empirical quantiles from samples generated by the non-parametric kernel density estimator.

According to one or more of the preceding aspects, the method includes, prior to computing the discrepancy value in respect of each node: reallocating the probability values within the classification probabilities associated with the nodes and neighbouring nodes to sharpen classification probabilities.

According to one or more of the preceding aspects, the method includes correcting the graph by modifying the topological information for the graph to isolate nodes identified as corrupt nodes from other nodes of the graph.

According to one or more of the preceding aspects, the nodes of the graph are each represented by respective feature vectors, and the topological information for the graph is represented by an adjacency matrix that indicates a presence or absence of edge connections between the nodes, and correcting the graph comprises amending the agency matrix to indicate that any nodes identified as corrupt nodes have no edge connections to any other nodes.

According to one or more of the preceding aspects, the method includes inputting the graph to a graph neural network (GNN) to generate the classification probabilities associated with the node and the classification probabilities associated with neighbouring nodes; and inputting the corrected graph to the GNN to generate new classifications probabilities for the plurality of nodes of the graph.

According to one or more of the preceding aspects, the corrected graph includes a training subset of labelled nodes, the method including training the GNN using the corrected graph.

According to one or more of the preceding aspects, the method includes, selecting a subset of the nodes as being a potentially corrupt node subset, and selecting a further subset of nodes as a comparison node subset; wherein identifying corrupt nodes based on differences in discrepancy values comprises comparing a distribution of the discrepancy values determined in respect of the potentially corrupt node subset with a distribution of the discrepancy values determined in respect of the comparison node subset. In some example aspects, the distributions of the discrepancy values are maximum mean discrepancies.

According to a further example aspect, there is provided a processing device and a non-transitory storage medium coupled to the processing device, the storage medium storing instructions that when executed by the processing device configures the processing system to detect corrupt nodes in a graph that comprises a plurality of corrupt nodes and clean nodes and topology information that defines connections between the nodes by: computing, for each of a plurality of nodes of the graph, a discrepancy value in respect of the node, wherein the discrepancy value for each node indicates a statistical discrepancy for classification probabilities associated with the node and classification probabilities associated with neighbouring nodes; and identifying corrupt nodes based on differences in discrepancy values.

According to a further example aspect, there is provided a computer program product comprising a computer readable medium having stored thereon instructions that when executed by the processing device configures the processing system to detect corrupt nodes in a graph that comprises a plurality of corrupt nodes and clean nodes and topology information that defines connections between the nodes by: computing, for each of a plurality of nodes of the graph, a discrepancy value in respect of the node, wherein the discrepancy value for each node indicates a statistical discrepancy for classification probabilities associated with the node and classification probabilities associated with neighbouring nodes; and identifying corrupt nodes based on differences in discrepancy values.

According to further example aspect, the present disclosure describes a method for detecting potentially perturbed nodes in a graph that comprises potentially perturbed nodes and clean nodes. The method includes calculating, for each of a plurality of nodes of the graph, a discrepancy value in respect of the node, wherein the discrepancy value for each node indicates a statistical discrepancy for classification probabilities associated with the node and classification probabilities associated with neighbouring nodes; fitting a statistical distribution for the discrepancy values for the clean nodes; determining a detection threshold for potentially perturbed nodes based on the statistical distribution; and identifying nodes having a discrepancy value greater than the detection threshold as potentially perturbed nodes.

According to a further example aspect is a method for detecting a subset of corrupted nodes in a graph, comprising: for a graph that includes a suspicious node subset of nodes that is suspected to be a corrupted subset, selecting a further subset of nodes as a comparison node subset; calculating, for each of the nodes in the suspicious node subset and comparison node subset a higher order feature in respect of the node that embeds information about the node and its neighbours; determining if a distribution of the higher order features for the suspicious node subset and comparison node subset have a same distribution or have a different distribution; and deeming that the suspicious node subset is a subset of corrupted nodes based on a determination that the distribution of the higher order features for the suspicious node subset and comparison node subset are different.

### BRIEF DESCRIPTION OF THE DRAWINGS

Reference will now be made, by way of example, to the accompanying drawings which show example embodiments of the present application, and in which:

FIG. 1 is a block diagram illustrating an example of a graph and a graph neural network (GNN);

FIG. 2 is a graphic illustration of an adversarial attack on a graph topology of a target node;

FIG. 3 is a block diagram illustrating an example of a perturbed node detection system according to example embodiments;

FIG. 4 is an illustrative plot of discrepancy values calculated for node neighbour groups by a perturbed node detector of the system of FIG. 3;

FIG. 5 is a block diagram illustrating an example of a perturbed node detection system according to an alternative example embodiment;

FIG. 6 is a block diagram illustrating an example of a method of using machine learning based graph processing in combination with perturbed node detection and topology correction;

FIG. 7 is a block diagram illustrating an example of a perturbed node detector for use in perturbed node detection system according to a further alternative example embodiment;

FIG. 8 is a block diagram illustrating an example of a perturbed node detection system according to example embodiments;

FIG. 9 is a block diagram illustrating an example processing system that may be used to execute machine readable instructions to implement a perturbed node detection system.

Similar reference numerals may have been used in different figures to denote similar components.

### DESCRIPTION OF EXAMPLE EMBODIMENTS

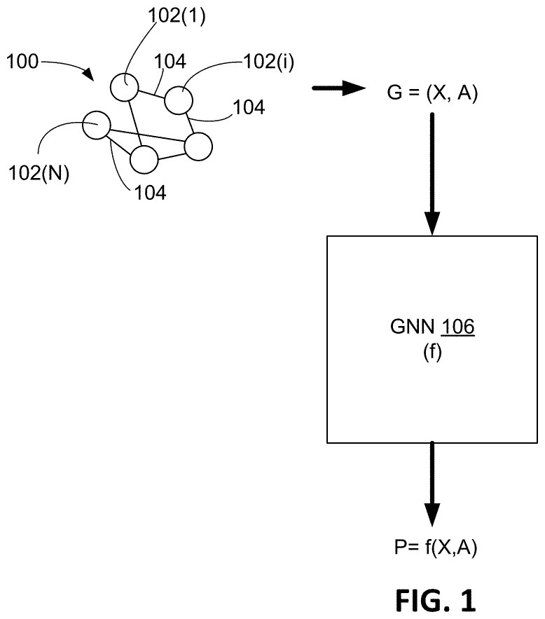

FIG. 1 illustrates an example of a graph 100 and a machine learning based system for processing the graph 100. In the illustrated example, the machine learning based system includes a graph neural network (GNN) 106. The graph 100 is a data structure which consists of nodes 102(1), . . . , 102(N) (referred to collectively herein as nodes 102 and individually as node 102 or 102(i)) and edges 104. Each node 102 represents an object in a set of objects and each edge 104 represents a relationship that connects two nodes 102. In example embodiments, the graph 100 can be represented by G=(X, A), where X ϵ [symbol] ^{N×D} is a feature matrix of node features, and A Γ [symbol] ^{N×N} is an adjacency matrix that provide topology information for the graph. In particular, adjacency matrix defines the connections (edges 104) between the nodes 102(1), . . . , 102(N). N is the number of nodes and D is the number of dimensions included in a feature vector v(i) (where i denotes an ith node 102(i) and 1≤i≤N) in the feature matrix X. Each dimension is a numeric value that represents a feature of the object that the node 102(i) represents. Accordingly, the feature matrix X includes data for each node 102(i) in the form of a respective D-dimensional feature vector v(i). In example embodiments, in addition to identifying edges 104 between nodes 102, the information included in adjacency matrix A may also include an edge weight and/or directional attributes for the edges 104.

GNN 106 is structured to process a graph (e.g. a data structure consisting of nodes and edges), and in this regard includes neural network (NN) layers interspersed with aggregating functions. Different architectures can be used to implement GNN 106. In an illustrative embodiment, GNN 106 is a graph convolution network (GCN) that is configured for semi-supervised learning. An example of such a GCN is described in: Kipf, T. N., & Welling, M. (2016), Semi-supervised classification with graph convolutional networks, ICLR 2017. In this regard, GNN 106 is configured to be trained using training samples that include graphs represented by G(X, A) in which a sub-set of the node feature vectors v(i) are provided with a respective labels y(i). GNN 106 is configured to perform classification to predict labels y(i) for the nodes 102 in the graph 100 represented by G=(X, A). More particularly, for a given input graph represented by G=(X, A), the GNN 106 outputs a probability matrix P=f(X, A). GNN 106 is a model (generally referred to as a GNN model) that maps an input graph represented by G=(X, A) to the probability matrix P using training samples as described in further detail below. The parameters of the GNN 106 (i.e. the GNN model) are learned during a training process. During the training process, parameters of the GNN 106 are updated iteratively, including for example the weights of NN layers of the GNN 106, to optimize a loss function. The GNN 106 may approximate the function, f(X, A). The probability matrix P includes, for each node 102(i), a probability metric p, that indicates the relative probability for each of a plurality (K) of possible candidate classes (e.g. class labels) for the node 102(i). In an example embodiment, the probability metric pᵢ is a probability metric which indicates the probability distribution across K candidate classes for each of the respective nodes 102(i). In some example embodiments, the probability metric pᵢ is a softmax which indicates the normalized probability distribution across K candidate classes for each of the respective nodes 102.

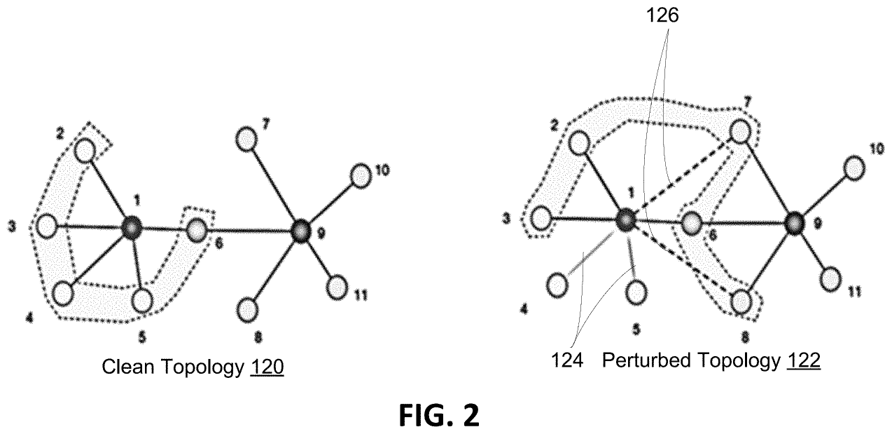

As noted above, it is possible that an adverse attack, or in some cases an unintentional data corruption, may occur that can alter the local topology around a target node 102(i) that results in degraded classification performance by GNN 106. For example, an adverse attack may delete edges 104 between a target node 102(i) and its legitimate direct neighbour nodes 102 and add edges between the target node 102(i) and non-legitimate neighbour nodes. Such an attack is graphically represented in FIG. 2, which shows a clean local graph topology 120 surrounding a target node 1, and a post-attack perturbed local topology 122 for node 1. In perturbed local topology 122, legitimate connecting edges 124 between node 1 and each of its direct neighbour nodes 4 and 5 have been removed and illegitimate direct connection edges 126 between node 1 and each of its formerly 2-hop neighbour nodes 7 and 8 have been constructed. Perturbed nodes 102 refer to nodes 102 that have had one or more connecting edges added or deleted to alter the legitimate local topology of the node 102. Clean nodes 102 are nodes 102 that have not had their legitimate local topology changed by the addition or deletion of the node 102. Although target node 1 has not been directly attacked, the alteration of its local topology results in a poisoned or perturbed node 1 that has an increased likelihood of being improperly classified by GNN 106. The reason for the decrease in classification accuracy is that the adversarial perturbations of the local topology create discrepancies between the feature data included in the feature vector v of target node 1 and that of its neighbours. By way of illustration, examples of possible target node attack algorithms are DICE (Delete Internally, Connect Externally) and Nettack as described in: “Zugner, D., Akbarnejad, A., & Gunnemann, S., Adversarial attacks on neural networks for graph data, In Proceedings of the 24th ACM SIGKDD International Conference on Knowledge Discovery & Data Mining, 2018.”

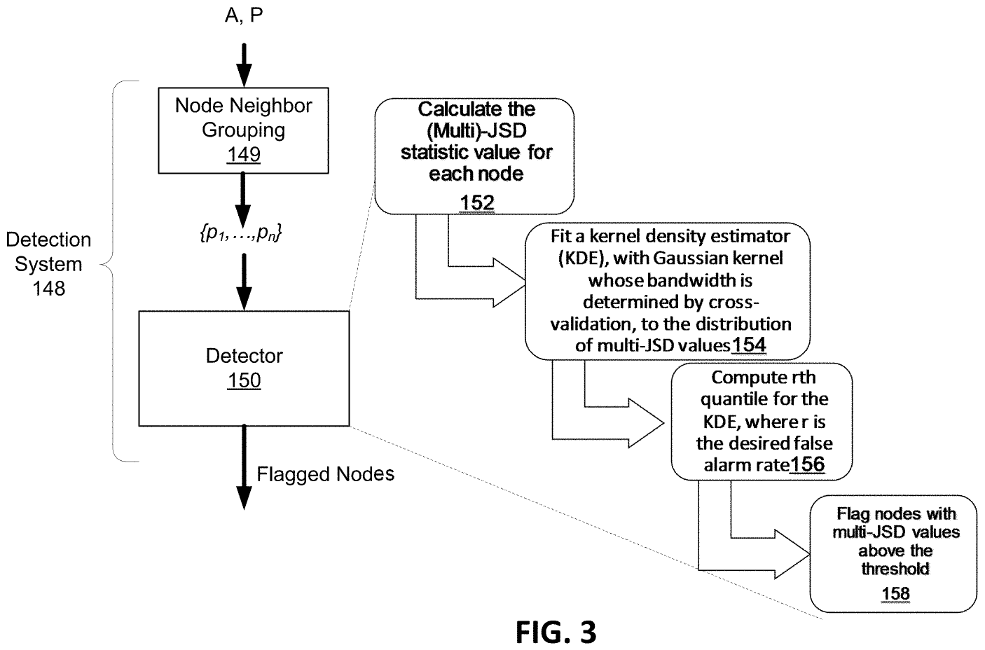

With reference to FIG. 3, example embodiments relate to a detection system 148 for detecting when a node 102(i) has been perturbed, including for example when the topology of a target node 102(i) is intentionally altered to create non-legitimate edges and/or delete legitimate edges. In some examples, the detection system 148 is configured to flag perturbed nodes while at the same time avoid false detections and thereby reasonably minimize the number of times clean nodes are mistakenly flagged as perturbed nodes.

As noted above, GNN 106 performs classification through aggregating information within local node neighbourhoods. The aggregated information is summarized in feature vectors extracted by the layers of the GNN 106 and these higher-order feature vectors (or node embeddings) capture similarities between nodes 102. Target node attack algorithms such as Nettack take advantage of this aggregation by intentionally creating discrepancies between the node embeddings of a target node 102(i) and the node embeddings of its neighbour nodes 102. As noted above, in example embodiments the GNN 106 outputs a probability matrix P that includes probability metrics pᵢ that each indicate the probability distribution across K candidate classes for a respective one of the nodes 102. These probability metrics pᵢ embed information about each respective node 102(i) and its neighbour nodes 102. As explained in greater detail below, in example embodiments the detection system 148 relies on discrepancies between the probability metrics pᵢ of a particular node 102(i) and its neighbour nodes 102 to determine if a particular node 102(i) has been perturbed.

As indicated in FIG. 3, in example embodiments the detection system 148 includes a software implemented node neighbour grouping function 149 that is configured to identify a node neighbour group in respect of each node 102(1), . . . 102(N) in graph 100. Each node neighbour group includes its respective node (for example node 102(i)) as a central node and any neighbour nodes 102 that are within k-hops of the central node 102(i). In some examples, k=1 such that only nodes 102 that are directly connected by an edge 104 with the central node 102(i) are included in the node neighbour group. In some examples, the number (k) of hops included in a node neighbour group may for example be based on the number of hops (k) evaluated by GNN 106 when processing graph G. Accordingly, node neighbour grouping function 149 identifies a set of k-hop neighbour nodes for each node 102(1), . . . 102(N) in graph 100. For example, in the case of ith node 102(i), the node neighbour group can include n nodes 102 from graph 100. The n nodes 102 each have an associated probability metric p, that indicates the probability distribution across K candidate classes for the nodes 102, such that the node neighbour group for node 102(i) has a corresponding set of n associated probability metrics {p₁, . . . , pₙ}. In some examples, the identification of node neighbour groups may be performed by a kernel or other structure within GNN 106.

In example embodiments, detection system 148 includes a software implemented detector function 150 that is configured to analyze the probability metrics {p₁, . . . , pₙ} associated with each node neighbour group to determine if the discrepancy across the probability metrics of the group are indicative of a perturbance, and if so, flag the central node of the node neighbour group. In this regard, operation of the detector function 150 in respect of the node neighbour group of central node 120 (i) will now be described with reference to blocks 152 to 158 of FIG. 3.

In example embodiments, detector function 150 is configured to determine a smoothness metric that measures discrepancy between the probability metric (e.g. p₁) of node 102(i) and those of its connected neighbour nodes 102 (e.g. p₂, . . . , pₙ). In example embodiments, this metric is determined by computing a statistic involving the prediction distribution probabilities of a node 102(i) and those of its connected neighbour nodes 102 within the node neighbour group:
discrepancy (p₁, . . . , pₙ),
   where probability metric p₁ indicates the output probabilities from GNN 106 for the ith node.

In one example, the smoothness metric is based on computing a multi-distribution Jensen-Shannon divergence (“multi-JSD”) value across the n probability metrics (p₁, . . . , pₙ) of node 102(i) and the nodes 102 within its neighbour node group, as represented by:

$$JSD ( {p}_{1} , … , {p}_{n} ) = ℍ ( \frac{1}{n} {\sum }_{j = 1}^{n} {p}_{j} ) - \frac{1}{n} {\sum }_{j = 1}^{n} ℍ ( {p}_{j} )$$

where H(p) is the Shannon entropy for distribution p.

As shown, the multi-JSD value for a particular node 102(i) is the difference between the Shannon entropy of the average of the probability metrics (p₁, . . . , pₙ) and the average of the Shannon entropies for each of the probability metrics (p₁, . . . , pₙ). A description of multi-JSD can be found in: “Nielsen, F. (2010); A family of statistical symmetric divergences based on Jensen's inequality; arXiv preprint arXiv:1009.4004.”

Accordingly, in an example embodiment, detector function 150 determines discrepancy within the nodes of each node neighbour group by calculating the multi-distribution Jensen-Shannon divergence (multi-JSD) of the probability metrics (p₁, . . ., pₙ) across the group. As indicated by block 152, a multi- JSD value is calculated for each node 102(1), . . . , 102(N) of the graph 100 based on the node neighbour group of each node 102(1), . . . , 102(N). An underlying assumption of the detector 150 is that in the case of a graph 100 that has perturbed nodes (e.g. nodes 102 that have had the topology of their node neighbour group corrupted) and clean nodes (i.e. nodes 102 that have not had their neighbour group topology corrupted), the multi-JSD values calculated in respect of the perturbed nodes will have a different statistical distribution than the multi-JSD values calculated in respect of the clean nodes. Accordingly, null hypothesis distributions are assumed in respect of the multi-JDS values for the clean nodes and the null nodes, respectively.

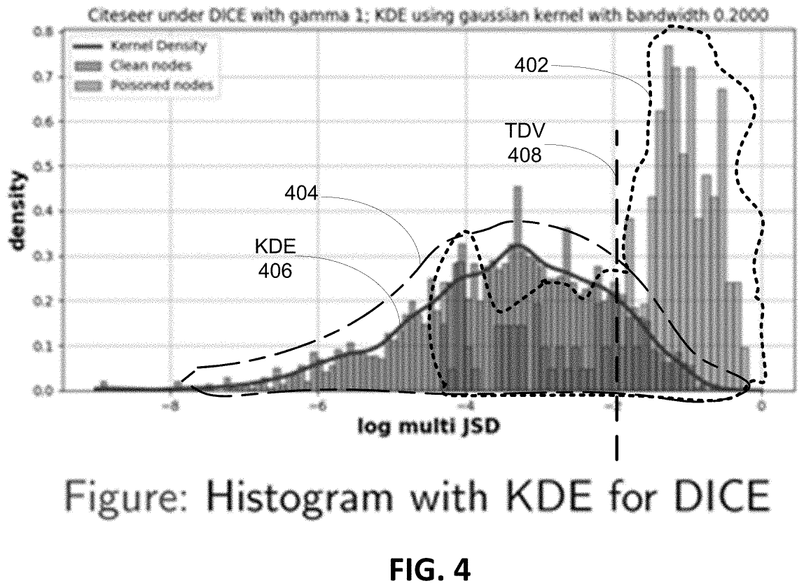

By way of example, FIG. 4 illustrates an example of a histogram plot of node density v. log multi-JSD values determined in respect of Citeseer graph data subjected to a DICE attack. The dashed line 402 generally encircles a set of multi-JSD values for known perturbed nodes and the dashed line 404 generally encircles a set of multi-JSD values for known clean nodes. Lines 402 and 404 are illustrative only of the relative distributions of clean and perturbed nodes as in practice the node detector system 148 will be unaware of what nodes are clean and what nodes are perturbed. According to example embodiments, based on the assumption that perturbed nodes and clean nodes have distinct distributions, detector function 150 is configured to fit a kernel density estimator (KDE) with Gaussian kernel whose bandwidth is determined by cross-validation, to the distribution of the multi-JSD values as indicated by block 154. In FIG. 4, line 406 illustrates a statistical distribution of multi-JSD values for as determined by detector function 150. An example of KDE functionality is described in: “Silverman, B. W. (2018); Density estimation for statistics and data analysis; Routledge

As indicated in block 156, detector function 150 is configured to calculate a threshold detection value (TDV) to compare with the multi-JSD values of the nodes 102 to identify the respective nodes as perturbed nodes or clean nodes.

In an example embodiment, a Neyman-Pearson procedure is applied and the threshold detection value TDV is calculated to using empirical quantiles from samples generated from the KDE function. An appropriate detection threshold value TDV is determined by matching the tail probability of the KDE statistical distribution to a target false positive rate. For example, in block 156 the rth quantile could be computed for the KDE, where r is the desired false alarm rate. Examples of a Neyman-Person procedure are described in: “Neyman, J.; Pearson, E. S. (1933-02-16). ‘IX. On the problem of the most efficient tests of statistical hypotheses’. Phil. Trans. R. Soc. Lond. A. 231 (694-706): 289-337”). By way of illustration, in the plot of FIG. 4, line 408 represents an example threshold detection value TDV that has been calculated by detector function 150 for a specific graph. In the illustrated example, the threshold detection value TDV has been set at log multi-JSD value=−2.

Once the threshold detection value TDV is set, the detector function 150 compares the multi-JSD value calculated for each node 102(1), . . . , 102(N) against the threshold detection value TDV as indicated in Block 158. The nodes 102 that have a multi-JSD value below the threshold detection value TDV are determined to be clean nodes and the nodes 102 that have a multi-JSD value above the threshold detection value TDV are determined to be perturbed nodes and are flagged accordingly. In an example embodiment, the detector function 150 outputs a list that identifies the nodes 102 that have been flagged as perturbed nodes. Referring again to the example illustrated in FIG. 4, all nodes 102 to the left of line 408 will be classed as clean nodes and all nodes 102 to the right of the line 408 will be classed as perturbed nodes. As can be appreciated from FIG. 4, some legitimately clean nodes encompassed within the tail of KDE distribution 406 will end up being incorrectly classified as perturbed nodes (e.g. false positives) and similarly some perturbed nodes within the KDE distribution 406 will end up being incorrectly classified as clean nodes. As noted above, in example embodiments the threshold detection value TDV is determined based on achieving an acceptable target false positive rate. In some examples, the target false positive rate may be a manually set processing attribute based on the particular type of graph data being processed and the use for that data. By way of illustrative example, a false positive rate of 10% could be set.

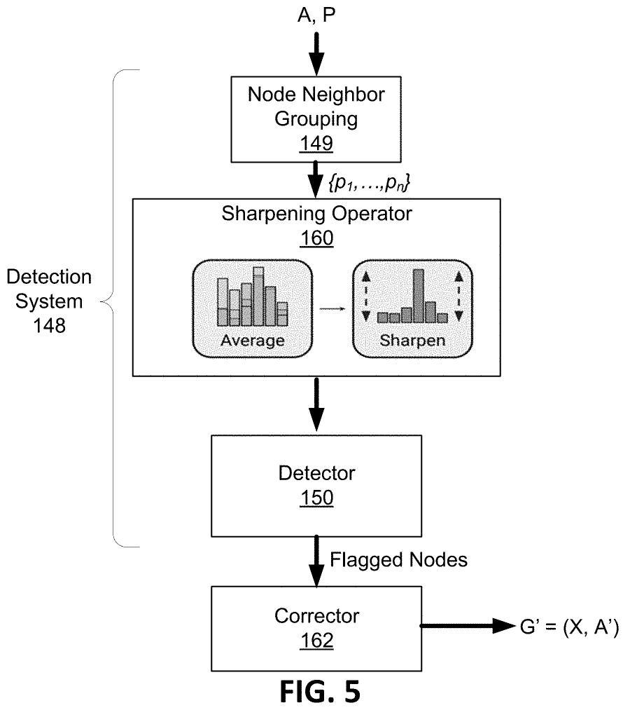

In some example embodiments, pre-processing may be applied to the probability metrics p included in probability matrix P before multi-JSD values are calculated for each of the respective nodes 102. In this regard, FIG. 5 shows a block diagram of detection system 148 that is identical to the detection system 148 of FIG. 3 except that detection system FIG. 5 includes a sharpening operator 160. Sharpening operator 160 is configured to sharpen each of the probability metrics p included in probability matrix P. Each probability metric p indicates a probability for K candidate classifications for its respective node, and the sharpening operator 160 is configured to reallocate the probabilities within a probability metric p to increase the probability of the highest probability classification relative to at least some of the other possible candidate classifications. By way of example, a possible sharpening calculation applied by sharpening operator 160 in respect of the probability metric p for node 102(i) can be represented as:

$$Sharpen {( p , T )}_{k} = {p}_{k}^{\frac{1}{T}} \text{/} {\sum }_{{k}^{′} = 1}^{K} {p}_{{k}^{′}}^{\frac{1}{T}}$$

In the above calculation, T represents a temperature, where 0<T≤1. When T=1, no sharpening occurs and when T≈0 the highest probability classification is increased to 100% probability. The sharpening operator takes a vector p of length K and a scalar T as arguments. The output of the sharpening operator is another vector of length K. The equation defines the operator by defining the kth component of the output vector (the kth component being a scalar).

In example embodiments the multi-JSD values are then calculated for each node 102 using the sharpened probability metrics pᵢ for that node 102 and the nodes 102 in its node neighbour group. So for example, in the case of node 102(i), the multi-JSD value for the node would be defined as:
JSD(Sharpen(p₁, T), . . . , Sharpen(pₙ, T))

It will be appreciated from the above description that perturbed node detection system 148 operates to flag a node 102(i) when discrepancy of the classification probabilities (e.g. probability metrics such as softmax or logits (p₁, . . ., pₙ)) determined by GNN 106 for the node 102(i) and its neighbours exceed a threshold detection value TDV. The presence of flagged nodes indicates that the topology of graph 100 has been unnaturally altered, perhaps through an intentional adversarial attack.

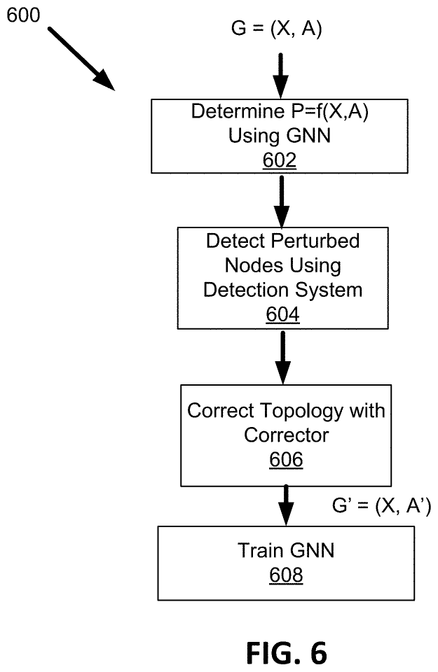

In some example embodiments, information generated by perturbed node detection system 148 can be used to correct the topology of a graph 100. In this regard, in example embodiments, GNN model 106 and perturbed node detection system 148 may be combined with a corrector function 162 (see FIG. 5). FIG. 6 illustrates an example embodiment of a method 600 that combines operation of GNN model 106, perturbed node detection system 148, and corrector function 162 to detect if a graph 100 (G=(X, A)) includes data suggestive of a topology attack on one or more nodes 102 and then take corrective action if required.

As indicated in FIG. 6, the method commences with graph G=(X, A) being input to GNN 106. In an illustrative example, parameters of the GNN model 106 are learned using semi-supervised learning and a training dataset, where the graph G is a training dataset. In this regard, a subset of the nodes 102 of graph G are pre-labelled with one of K possible classification labels, and the remaining nodes 102 of the graph are unlabeled. The parameters of the GNN 106 can be learned during a training process where the parameters of the GNN 106 are learned while the GNN 106 predicts labels y(i) for the unlabeled nodes 102 based in part on the known classification of the labelled nodes 102. In some examples, the GNN 106 is custom trained in respect of a specific input graph G, with the goal of the training process being to classify the unlabeled nodes in the graph. In some examples, once trained, the GNN 106 may be deployed and used to perform classification on new input graphs (by receiving new input graphs represented by G=(X, A), and outputting probability matrices P for each new input graph).

In an example embodiment, GNN 106 receives a new graph represented by G=(X, A), which is suspected to include one or more perturbed nodes. The new graph represented by G=(X, A) is intended for semi-supervised learning of the parameters of the GNN 106 and thus includes a subset of labelled nodes. In an example embodiment, in a pre-GNN training step, the GNN 106 processes the graph represented by G=(X, A) using initial parameters of the GNN 106 and generate an initial pre-trained GNN . As indicated in block 602, GNN 106 predicts a set of probabilities P=f(X, A) that includes a probability metric p, for each of the nodes 102 included in X. The probability metric p, for each node 102 specifies relative probabilities for K candidate classification labels for that node 102.

Perturbed node detection system 148 is used to detect and flag perturbed nodes based on the pre-trained GNN output using the method described above (Block 604). The list of perturbed nodes is then used by corrector function 160 to alter the adjacency matrix A of the graph G to isolate any nodes that have been flagged as perturbed nodes (Block 606 ). For example, adjacency matrix A can be amended to remove all direct edges to perturbed nodes, resulting in a revised graph represented by G′=(X, A′). By way of illustration, in the example of FIG. 2, the adjacency matrix A would be amended to remove all edges 124, 126 connecting node 1 to other nodes resulting in a revised adjacency matrix A′ in which the node neighbourhood group for node 1 would include only node 1. The revised topology of the graph is represented by G′=(X, A′) will not be identical to the original, un-attacked topology of graph represented by G=(X, A) pre-attack, but will, in at least some scenarios, mitigate against potentially negative inferences that would result if illegitimate edges were considered during classification of the graph represented by G=(X, A).

In example embodiments, as indicated in Block 608, the modified graph represented by G′=(X, A′) is then used as the input dataset to train GNN 106 to further learn the parameters of the GNN 106 (i.e., the parameters of the GNN model) and eventually generate a final set of probabilities P=f(X, A). Accordingly, in the example of FIG. 6, the system first learns a modified adjacency matrix A′, and then uses that modified adjacency matrix A′ for the actual learning of the parameters of the GNN 106 that are used to generate a final set of probabilities. The unlabelled nodes are labelled based on the final set of probabilities once the performance of GNN 106 has been optimized.

In some examples, the graph represented by G=(X, A) may not be a training dataset, but rather a new graph represented by G=(X, A). In this embodiment, in block 602 the GNN 106 will be used to generate a set of probabilities that are used to detect perturbed node that are then used to correct adjacency matrix A. In block 608, GNN 106 will be applied to the amended graph (G,A′) and the GNN 106 outputs the predicted probability matrix P for the new graph represented by G=(X, A).

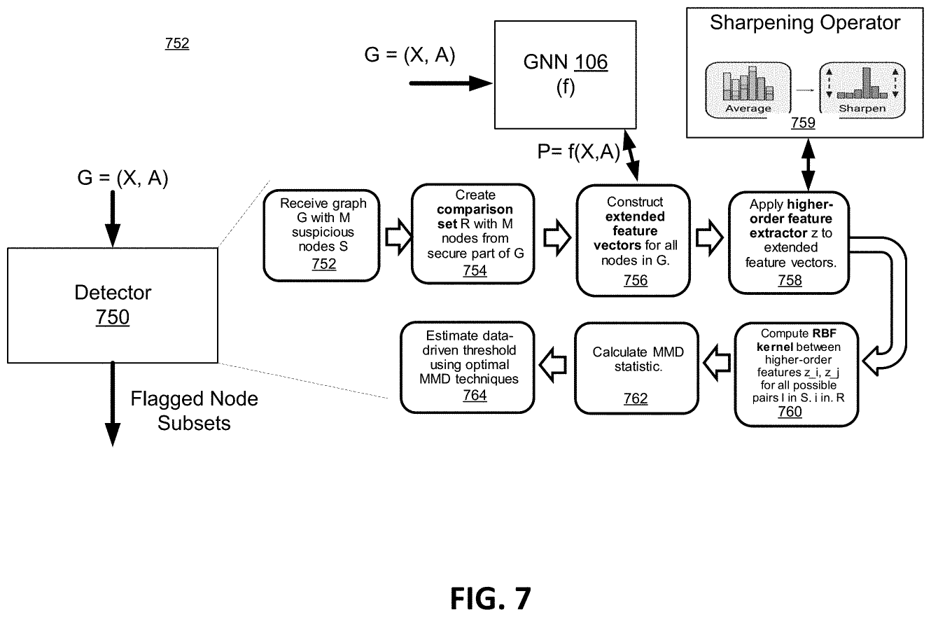

In some example embodiments, different discrepancy computations than multi-JSD can be applied by the detector 150, and different statistical fittings other than that obtained using a KDE function used to define the distribution of clean nodes. In this regard, FIG. 7 provides an alternative embodiment for detector 150.

In the example of FIG. 7, instead of calculating multi-JSD values for each node 102(i), two separate Jensen-Shannon (JS) based discrepancy calculations, prox₁(i) and prox₂(i), are performed as follows in respect of each node 102(i) (block 702):

$${prox}_{1} ( i ) = \frac{1}{𝒩 ( i )} {\sum }_{j ∈ 𝒩 ( i )} {D}_{JS} ( {p}_{i} \vert \vert {p}_{j} )$$

$${prox}_{2} ( i ) = \frac{1}{𝒩 ( i )} {\sum }_{j ∈ 𝒩 ( i )} {\sum }_{k ∈ 𝒩 ( i )} {D}_{JS} ( {p}_{j} \vert \vert {p}_{k} )$$

Where: D_{JS}(pⱼ∥pₖ) is the Jensen-Shannan divergence between the probability metric pair pⱼ, pₖ and N(i) is number of nodes in the neighbour node group of node 102(i). As noted above, p, indicates the GCN output softtmax probabilities for the ith node.

Accordingly, prox₁(i) is the mean of the JS divergences between the softmax probabilities of a node 120(i) and the other nodes in its node neighbour group. Prox₂(i) is the mean of the JS divergences between the softmax probabilities of all pairs of neighbours in the node neighbour group of node 102(i).

As with the multi-JSD metric used in the above examples, null hypothesis distributions are also assumed for each of the proxi and prox 2 values calculated for the nodes 102 of graph 100, namely that the values calculated in respect of perturbed nodes and clean nodes will each have respective statistical distributions. A Gaussian distribution is determined for fitting to the nodes (Block 704). Threshold detection values T1 and T2 are then determined for each of the prox₁ and prox₂ distributions by matching the tail probabilities to a specific target false positive fail rate (Block 706). Instead of using the KDE function noted above, the threshold value calculations can be done using an inverse cumulative distribution function (cdf). The Neyman-Pearson lemma can be used to set the threshold detection values T1 and T2. As per block 708, the prox₁ and prox₂ values calculated in respect of each of the nodes 102 can be compared against the respective thresholds T1 and T2, and nodes that exceed either threshold flagged as perturbed nodes.

In addition to attacks on the local topology of a single node, it is also possible that a subset of the nodes 102 of a graph 100 can be perturbed, resulting in a subset of corrupted nodes. In this regard, a subset of corrupted nodes refers to a set of nodes that have been targeted by a graph topology attack in which edges 104 that have at least one endpoint (i.e. node connection) within the set have been added or deleted.

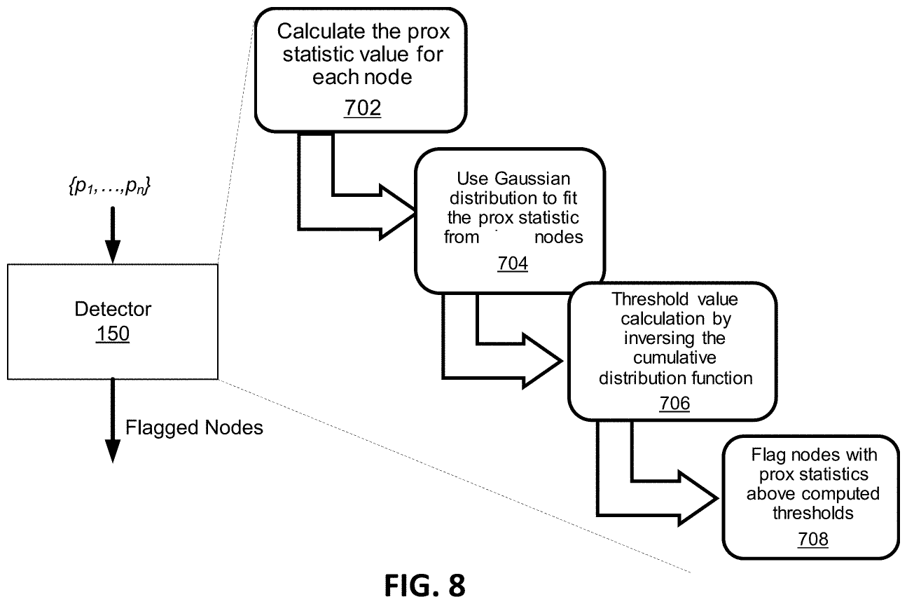

Referring to FIG. 8, example embodiments of a detection system for detecting corruption in a subset of the nodes of the graph 100 represented by G=(X, A). Example embodiments are based on the assumption that in at least some scenarios, the introduction and/or removal of legitimate edges 104 leads to detectable inconsistencies between the information provided by the graph 100 (i.e. information included in adjacency matrix A) and node features (i.e. information included in feature matrix X).

Detection system 750 is configured to apply a two sample statistical hypothesis test to flag a corrupted node subset. As indicated at block 152, the detection system 750 is configured to receive as input a graph represented by G=(X, A) that includes a set N of nodes in total. A subset S of the nodes is suspected of being corrupted. The subset S of suspicious nodes includes M nodes. As indicated in block 754, the detection system 750 is configured to select a comparison subset R of M nodes from the graph represented by G=(X, A). The comparison subset R is comprised of nodes that are not suspected of being corrupted. A further subset T includes the remaining nodes of G=(X, A) that are not part of suspicious subset S or comparison subset R set of nodes.

As indicated in block 756, the detection system 750 is configured to construct an extended feature vector (x₁, . . . ,x_{N}) for all nodes 102 in the graph represented by G=(X, A). In one example, embodiment, the extended feature vectors x₁, . . . , x_{N} are the output softmax probability metrics (i.e. extended feature vector x₁, . . . , x_{N}=softmax probability metric p₁, . . . , p_{N,} respectively) that are generated by GNN 106 in respect of each of the nodes 102 in graph represented by G=(X, A). The probability metric for each node 102(i) embeds information about that node and its neighbour nodes. Thus, each extended feature vector xᵢ=pᵢ includes both local topology information and node attribute information. In some examples, GNN 106 may first be trained using training samples from graph G=(X, A) that includes only the node subset T of the nodes that does not include suspicious subset S or comparison subset R, and the trained GNN 106 is used to output the predicted probability matrix P=f(Z,A) that includes probability metrics p₁, . . . , p_{N} for all of the nodes in graph represented by G=(X, A).

As indicated in block 758, a higher order feature extractor is then applied to the extended feature vectors X=p₁, . . . , p_{N} to generate a higher order feature vector zᵢ for each node 102(i). In example embodiments, the higher order feature zᵢ vectors indicates smoothness within node neighbor groups included in the graph subsets S,R,T. In example embodiments, the neighbour group of a node 102(i) includes any neighbour nodes 102 that are within k-hops of the central node 102(i). In some examples, k=1 such that only nodes 102 that are directly connected by an edge 104 with a central node 102(i) are included in the neighbour group for that node. For example, in the case of ith node 102(i), the node neighbour group can include n nodes 102 from graph 100. The n nodes each have an associated logit that indicates the probability distribution across K candidate classes for the nodes, such that the node neighbour group for node 102(i) has a corresponding set of n associated logits {p₁, . . . , pₙ}. In some examples, the identification of node neighbour groups may be performed by a kernel or other structure within GNN 106.

In one example, the higher order feature zᵢ is a smoothness metric that measures discrepancy between the logit (e.g. pᵢ) of node (i) and those of its connected neighbour nodes (e.g. the node neighbour group p₂, . . . , pₙ). In example embodiments, this metric is determined by computing a statistic involving the prediction distribution probabilities of a node 102(i) and those of its connected neighbour nodes 102:
discrepency (p₁, . . . , pₙ)
   where probability metric p, indicates the output probabilities from GNN 100 for the ith node.

In one example, the smoothness metric is based on computing a multi-distribution Jensen-Shannon divergence (“multi-JSD”) value across the n probability metrics (p₁, . . ., pₙ) of node 102(i) and the nodes 102 within its neighbour node group, as represented by:

$$JSD ( {p}_{1} , … , {p}_{n} ) = ℍ ( \frac{1}{n} {\sum }_{j = 1}^{n} {p}_{j} ) - \frac{1}{n} {\sum }_{j = 1}^{n} ℍ ( {p}_{j} )$$

where H(p) is the Shannon entropy for distribution p.

As shown, the multi-JSD value for a particular node 102(i) is the difference between the Shannon entropy of the average of the probability logits (p₁, . . ., pₙ) and the average of the Shannon entropies for each of the probability logits (p₁, . . ., pₙ). As noted above, a description of multi-JSD can be found in: “Nielsen, F. (2010); A family of statistical symmetric divergences based on Jensen's inequality; arXiv preprint arXiv: 1009.4004.”

Accordingly, as indicated at block 758, detection system 750 determines discrepancy within the nodes of each node neighbour group by computing the multi-distribution Jensen-Shannon divergence (multi-JSD) of the probability logits (p₁, . . ., pₙ) across the group. As indicated by block 752, a multi-JSD value is computed for each node 102(1), . . . , 102(N) of the graph 100 based on the node neighbour group of each node 102(1), . . . , 102(N).

In some example embodiments, pre-processing may be applied to the probability metric pᵢ included in probability matrix P before multi-JSD values are calculated for each of the respective nodes 102. In this regard, in some examples detection system 750 includes a sharpening operator 159 associated with block 758. Sharpening operator 759 is configured to sharpen each of the probability metrics pᵢ included in probability matrix P. Each probability metric pᵢ indicates a probability for K candidate classifications for its respective node, and the sharpening operator 759 is configured to reallocate the probabilities within a probability metric pᵢ to increase the probability of the highest probability classification relative to at least some of the other possible candidate classifications. By way of example, a possible sharpening calculation applied by sharpening operator 759 in respect of the probability metric pᵢ for node 102(i) can be represented as:

$$Sharpen {( p , T )}_{k} = {p}_{k}^{\frac{1}{T}} \text{/} {\sum }_{{k}^{′} = 1}^{K} {p}_{{k}^{′}}^{\frac{1}{T}}$$

In the above calculation, T represents a temperature, where 0<T≤1. When T=1, no sharpening occurs and when T≈0 the class with the highest probability is increased to 100%.

In example embodiments, the multi-JSD values are then calculated for each node 102 using the sharpened probability metrics p for that node and the nodes in its node neighbour group. So for example, in the case of node 102(i), the multi-JSD value for the node would be defined as:
JSD (Sharpen(p₁, T), . . . , Sharpen(pₙ, T))

Accordingly, in example embodiments, the output of block 758 comprises three sets of higher order features z: a set ZS corresponding to the suspicious node subset S; a set ZR corresponding to the reference node subset R; and a set ZT correspond to the remaining node subset. In example embodiments, the higher order feature zi for each node 102(i) is a multi-JSD value determined based on sharpened probability logits for the node 102(i) and its neighbor group. Alternatively, in some examples, the higher order feature zᵢ for each node 102(i) is a multi-JSD value determined based directly on unsharpened probability metrics pᵢ for the node 102(i).

In example embodiments, two hypothesis are considered by the detection system 750 to determine if suspicious node subset S should be flagged as corrupted. The first hypothesis is a null hypothesis that assumes if there is no node corruption in suspicious node subset S then the nodes in the combined subsets S and R will be identically and independently distributed (i.i.d.) vectors, generated from a first distribution p. The second hypothesis is the alternative hypothesis that assumes that if there is in fact node corruption in suspicious node subset S then the nodes in the subset R will be identically and independently distributed (i.i.d.) vectors, generated from a distribution q≠p.

In summary, in example embodiments, detection system 750 operates based on the assumption that the distribution of the higher order features z for the suspicious node subset S and comparison subset R will have the same distribution if the suspicious node subset S is not corrupted and different distribution if the suspicious node subset S is in fact corrupted.

Accordingly, in example embodiments, the detection system 750 is configured to apply a statistical test to determine which of the null hypothesis or the alternative hypothesis applies in respect of a particular suspicious node subset

S, comparison node subset R and remaining node subset T combination.

In this regard, as indicated in block 760, detection system 750 is configured to use a radial basis function (RBF) kernel to find an optimal bandwidth trough cross validation. For example, the RBF kernel can be computed between higher order feature vectors z for all possible pairs in subset S and z for all possible pairs in subset R.

As indicated in block 762, a non-parametric maximum mean discrepancy (MMD) statistic is then determined based on the RBF kernel computation, and data driven threshold determined using optimal MMD techniques (block 764). In some example embodiments, the threshold is set with consideration to a false positive threshold.

The thresholds are then be applied to determine whether: (i) the alternative null hypothesis applies to a suspicious node subset S, in which case the subset S is deemed to be a corrupted node subset; or (ii) the null hypothesis applies, in which case the suspicious node subset S is deemed to be un-corrupted. The detection system 750 outputs the determined result, which may in some examples be used to take remedial action such performing further analysis on graph represented by G=(X, A) or modifying the graph represented by G=(X, A) to discard the corrupted node set S from the graph represented by G=(X, A).

Possible areas of application that the perturbed node detection system 148, the detection system 50, and the methods described above may applied to may include:

(1) Social networks: In large networks such as FaceBook™ and LinkedIn™, malicious users may attempt information and identity theft through hijacking of vulnerable accounts; the perturbed node detection system and method may in some scenarios be able to detect and deter such attacks.

(2) Financial networks: Credit prediction is a common task when financial data for a network of users are available. This prediction task exploits use-user interactions. For instance, a user connected to many users with high credit is likely to have high credit. As with social networks, it is possible for a malicious user to masquerade as a high-credit user by either hijacking accounts or adding false connections to high-credit users; the perturbed node detection system and method may in some scenarios be able to detect and deter such attacks.

(3) Sensor networks: In a sensor network, the malfunction of some sensors could cause cascading effect and lead to the breakdown of the overall system; the perturbed node detection system and method may be able to provide early detection of abnormal sensorsin some scenarios.

(4) Web graphs: Popular webpage search algorithms such as PageRank treat hyperlinks between pages as votes of support. Thus, webpages with high rank are treated as trusted authorities. Malicious webpages can boost traffic by artificially inflating their rank through addition of fraudulent hyperlinks to the malicious webpage. The perturbed node detection system and method may in some scenarios be able to detect and deter such activity.

(5) Recommendation system networks: Many popular e-commerce platforms such as Amazon™ and eBay™ rely on product recommendations to drive sales. Some platforms are starting to apply graph mining techniques to boost product recommendations. In this scenario, a malicious seller on the platform can manipulate the recommendation graph by adding fraudulent links to drive traffic to products sold by the malicious seller. Often, malicious sellers can form a cartel and drive traffic to each other's products. The perturbed node detection system and method may in some scenarios be used to detect a seller or groups of sellers who exploit vulnerabilities to engage in unfair business practices.

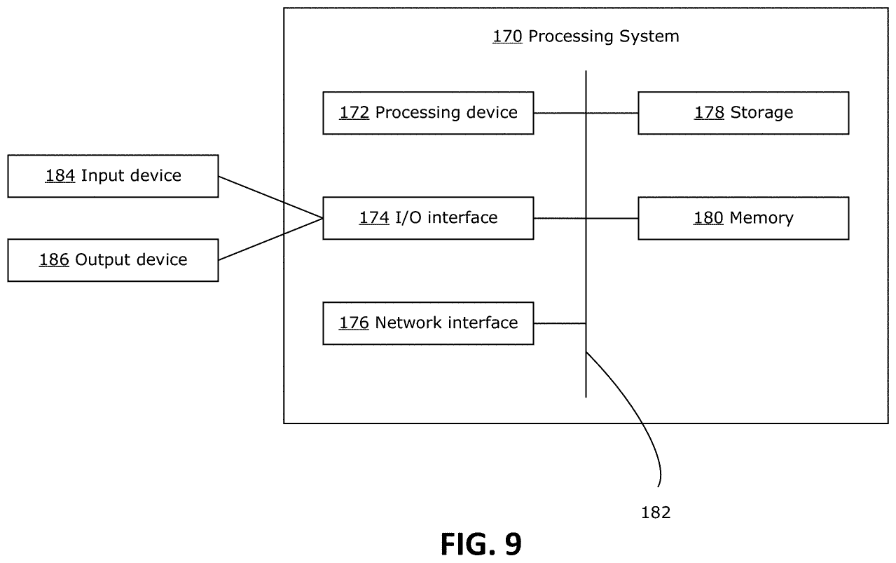

FIG. 9 is a block diagram of an example processing system 170, which may be used to execute machine executable instructions of GNN 106, detection system 148, or functions of detection system 148 (e.g., node neighbor grouping 149, detector 150, sharpening operator 160 ), or corrector function 162. Other processing units suitable for implementing embodiments described in the present disclosure may be used, which may include components different from those discussed below. Although FIG. 9 shows a single instance of each component, there may be multiple instances of each component in the processing unit 170.

The processing unit 170 may include one or more processing devices 172, such as a processor, a microprocessor, an application-specific integrated circuit (ASIC), a field-programmable gate array (FPGA), a dedicated logic circuitry, or combinations thereof. The processing unit 170 may also include one or more input/output (I/O) interfaces 174, which may enable interfacing with one or more appropriate input devices 184 and/or output devices 186. The processing unit 170 may include one or more network interfaces 176 for wired or wireless communication with a network.

The processing unit 170 may also include one or more storage units 178, which may include a mass storage unit such as a solid state drive, a hard disk drive, a magnetic disk drive and/or an optical disk drive. The processing unit 170 may include one or more memories 180, which may include a volatile or non- volatile memory (e.g., a flash memory, a random access memory (RAM), and/or a read-only memory (ROM)). The memory(ies) 180 may store instructions for execution by the processing device(s) 172, such as to carry out examples described in the present disclosure. The memory(ies) 180 may include other software instructions, such as for implementing an operating system and other applications/functions.

There may be a bus 182 providing communication among components of the processing unit 170, including the processing device(s) 172, I/O interface(s) 174, network interface(s) 176, storage unit(s) 178 and/or memory(ies) 180. The bus 182 may be any suitable bus architecture including, for example, a memory bus, a peripheral bus or a video bus.

The methods and systems described above provide a solution wherein corrupted nodes can be identified based on information that is included in neighboring nodes. In at least some applications the system will mitigate against flawed and inaccurate classification data being used in downstream processes. In some embodiments, the knowledge of corrupted nodes can be used to remove suspicious nodes and correct graph data before a classifier GNN is trained, thereby resulting in a more accurate classifier GNN. In at least some examples early detection of corrupt data may improve the efficiency and accuracy of downstream processes and/or assist in identifying corrupt or erroneous upstream process. The may enable more accurate and efficient use of computing resources.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of all published papers identified in this disclosure are incorporated herein by reference.

What is claimed is:

1. A method for detecting corrupt nodes in a graph that comprises a plurality of corrupt nodes and clean nodes and topology information that defines connections between the nodes, comprising:
computing, for each of a plurality of nodes of the graph, a discrepancy value in respect of the node, wherein the discrepancy value for each node indicates a statistical discrepancy for classification probabilities associated with the node and classification probabilities associated with neighbouring nodes; and
identifying corrupt nodes based on differences in discrepancy values.

2. The method of claim 1, wherein identifying corrupt nodes based on differences in discrepancy values comprises:
fitting a statistical distribution for the discrepancy values for the clean nodes;
determining a detection threshold for corrupt nodes based on the statistical distribution; and
identifying nodes having a discrepancy value greater than the detection threshold as corrupt nodes.

3. The method of claim 2, wherein the discrepancy value is based on a multi-distribution Jenson Shannon divergence calculation.

4. The method of claim 2, wherein fitting the statistical distribution comprises using a non-parametric kernel density estimator, and the detection threshold is determined based on empirical quantiles from samples generated by the non-parametric kernel density estimator.

5. The method of claim 1, further comprising, prior to computing the discrepancy value in respect of each node: reallocating the probability values within the classification probabilities associated with the nodes and neighbouring nodes to sharpen classification probabilities.

6. The method of claim 1, further comprising correcting the graph by modifying the topological information for the graph to isolate nodes identified as corrupt nodes from other nodes of the graph.

7. The method of claim 6, wherein the nodes of the graph are each represented by respective feature vectors, and the topological information for the graph is represented by an adjacency matrix that indicates a presence or absence of edge connections between the nodes, and correcting the graph comprises amending the agency matrix to indicate that any nodes identified as corrupt nodes have no edge connections to any other nodes.

8. The method of claim 6, further comprising:
inputting the graph to a graph neural network to generates the classification probabilities associated with the node and the classification probabilities associated with neighbouring nodes; and
inputting the corrected graph to the graph neural network to generate new classifications probabilities for the plurality of nodes of the graph.

9. The method of claim 8, wherein the corrected graph includes a training subset of labelled nodes, the method including training the graph neural network using the corrected graph.

10. The method of claim 1, further comprising:
selecting a subset of the nodes as being a potentially corrupt node subset, and selecting a further subset of nodes as a comparison node subset;
wherein identifying corrupt nodes based on differences in discrepancy values comprises comparing a distribution of the discrepancy values determined in respect of the potentially corrupt node subset with a distribution of the discrepancy values determined in respect of the comparison node subset.

11. The method of claim 10, wherein the distributions of the discrepancy values are maximum mean discrepancies.

12. A processing system comprising a processing device and a non-transitory storage medium coupled to the processing device, the storage medium storing instructions that when executed by the processing device configures the processing system to detect corrupt nodes in a graph that comprises a plurality of corrupt nodes and clean nodes and topology information that defines connections between the nodes by performing the actions of:
computing, for each of a plurality of nodes of the graph, a discrepancy value in respect of the node, wherein the discrepancy value for each node indicates a statistical discrepancy for classification probabilities associated with the node and classification probabilities associated with neighbouring nodes; and
identifying corrupt nodes based on differences in discrepancy values.

13. The processing system of claim 12, wherein identifying corrupt nodes based on differences in discrepancy values comprises:
fitting a statistical distribution for the discrepancy values for the clean nodes;
determining a detection threshold for corrupt nodes based on the statistical distribution; and
identifying nodes having a discrepancy value greater than the detection threshold as corrupt nodes.

14. The processing system of claim 13, wherein the discrepancy value is based on a multi-distribution Jenson Shannon divergence calculation, fitting the statistical distribution comprises using a non-parametric kernel density estimator, and the detection threshold is determined based on empirical quantiles from samples generated by the non-parametric kernel density estimator.

15. The processing system of claim 12, further comprising, prior to computing the discrepancy value in respect of each node: reallocating the probability values within the classification probabilities associated with the nodes and neighbouring nodes to sharpen classification probabilities.

16. The processing system of claim 12 comprising correcting the graph by modifying the topological information for the graph to isolate nodes identified as corrupt nodes from other nodes of the graph.

17. The processing system of 16, wherein the nodes of the graph are each represented by respective feature vectors, and the topological information for the graph is represented by an adjacency matrix that indicates a presence or absence of edge connections between the nodes, and correcting the graph comprises amending the agency matrix to indicate that any nodes identified as corrupt nodes have no edge connections to any other nodes.

18. The processing system of claim 16, comprising:
inputting the graph to a graph neural network to generates the classification probabilities associated with the node and the classification probabilities associated with neighbouring nodes; and
inputting the corrected graph to the graph neural network to generate new classifications probabilities for the plurality of nodes of the graph

19. The processing system of 18, further comprising:
selecting a subset of the nodes as being a potentially corrupt node subset, and selecting a further subset of nodes as a comparison node subset;
wherein identifying corrupt nodes based on differences in discrepancy values comprises comparing a distribution of the discrepancy values determined in respect of the potentially corrupt node subset with a distribution of the discrepancy values determined in respect of the comparison node subset.

20. A non-transitory computer readable medium storing instructions which, when executed by a processing device of a processing system, causes the processing system to detect corrupt nodes in a graph that comprises a plurality of corrupt nodes and clean nodes and topology information that defines connections between the nodes by performing the actions of:
computing, for each of a plurality of nodes of the graph, a discrepancy value in respect of the node, wherein the discrepancy value for each node indicates a statistical discrepancy for classification probabilities associated with the node and classification probabilities associated with neighbouring nodes; and
identifying corrupt nodes based on differences in discrepancy values.
